(19) United States
(12) Patent Application Publication
(10) Pub. No.: US 2017/0088036 A1
(43) Pub. Date: Mar. 30, 2017

(54) HEADLAMP DEVICE FOR A VEHICLE AND METHOD FOR CONTROLLING THE HEADLAMP DEVICE

(71) Applicant: GM GLOBAL TECHNOLOGY OPERATIONS LLC, Detroit, MI (US)

(72) Inventors: Philipp ROECKL, Ruesselsheim (DE); Ingolf SCHNEIDER, Ruesselsheim (DE); Rouven HABERKORN, Ruesselsheim (DE); Frank LANGKABEL, Ruesselsheim (DE)

(73) Assignee: GM GLOBAL TECHNOLOGY OPERATIONS LLC, Detroit, MI (US)

(21) Appl. No.: 15/276,132

(22) Filed: Sep. 26, 2016

(30) Foreign Application Priority Data
Sep. 25, 2015 (DE) 102015012568.0

(51) Int. Cl. B60Q 1/08; B60Q 1/14

(52) U.S. Cl. CPC B60Q 1/085; B60Q 1/143; B60Q 2300/42; B60Q 2300/23; B60Q 2300/056

(57) ABSTRACT

A headlamp device for a vehicle is provided to generate a light beam having a directed spotlight having an illumination direction and a spotlight distribution, and an orientation light having a broader orientation light distribution than the spotlight. The illumination direction of the spotlight is adjustable horizontally and vertically and the spotlight distribution may be at least partly suppressed to avoid dazzling other road users.

### CROSS-REFERENCE TO RELATED APPLICATION

This application claims priority to German Patent Application No. 102015012568.0, filed Sep. 25, 2015, which is incorporated herein by reference in its entirety.

### TECHNICAL FIELD

The present disclosure pertains to a headlamp device for a vehicle and a method for controlling the headlamp device.

### BACKGROUND

Vehicle headlamp systems are constantly being developed to include more and more headlamp devices that can be actuated by special controllers to ensure on the one hand that a driver of the vehicle can see the road he or she is driving on and objects of importance as early as possible, and on the other hand to avoid dazzling other road users. Accordingly, an automatic dipping system serves to suppress the main beam in certain areas of the main beam distribution to protect other road users from being dazzled.

The suppression of certain areas of the main beam distribution by the automated system is known by various names including Glare-Free-High-Beam (GFHB), Automatic GFHB or Adaptive Driving Beam (ADB). In order to avoid dazzling other road users, the main beam must be restricted, but this can also limit the vehicle driver's view and thus considerably impair his driving comfort and driving safety.

### SUMMARY

The present disclosure provides a headlamp device and a method for controlling the device with the purpose of improving the driving comfort and driving safety of the vehicle driver. According to a first aspect of the present disclosure, a headlamp device for a vehicle for generating a light beam includes a directed spotlight with an illumination direction and a spotlight distribution, and an orientation light which has a broader orientation light distribution than the spotlight. The illumination direction of the spotlight is adjustable horizontally and vertically and the spotlight distribution may be at least partly dimmed to avoid dazzling other road users. Accordingly, an adaptive headlamp device is provided so that certain zones in the driver's field of vision can be lit selectively without dazzling other road users through the adjustability and dimming capability of the spotlight. This improves both driving safety and overall driving experience when driving at night. The illumination direction of the spotlight is defined as the direction of the primary spotlight distribution when the light from the spotlight is not restricted (i.e., suppression is not activated).

In one embodiment of the present disclosure, the orientation light distribution is essentially below a glare plane. On level roads, the glare plane is defined as a plane parallel to the plane of the road and at about half the height of the headlamp, below which a direct headlamp beam cannot dazzle other road users. Thus, other road users cannot be dazzled by the orientation light on a level road.

In one embodiment of the present disclosure, the upper edge of the orientation light distribution can be defined by means of an adjustable screen in the beam path of the orientation light. It is thus possible ⁻to avoid dazzling oncoming traffic with the orientation light even on uneven roads for example by adjusting the screen.

According to one embodiment of the present disclosure, the spotlight distribution is essentially above the glare plane. in this way, the spotlight may serve to illuminate distant areas which lie outside the illumination field of the orientation light.

In one embodiment of the present disclosure, the illumination direction of the spotlight is adjustable mechanically. This may be carried out most simply by the mechanical displacement of one or more optical elements, such as lenses and/or reflectors in the beam path of the spotlight or by re-aligning the entire spotlight module.

According to one embodiment of the present disclosure, when the spotlight is not suppressed, the central area of the spotlight distribution has greater luminous intensity on average than the peripheral areas. This ensures that objects close to the light source—on the side of the road, for example—are not illuminated too intensively, while more distant areas of interest are lit more brightly.

According to one embodiment of the headlamp device, semiconductor light sources, particularly LEDs or semiconductor lasers, are used as the lighting means. Semiconductor sources are characterized by a long service life and high efficiency. Light quality and luminous intensity can also be further enhanced by the use of semiconductor lasers.

In one embodiment of the present disclosure, a LED matrix light source is provided as the spotlight source. In this way, the illumination direction and suppression may both be adjusted simply by actuation of the LEDs in the LED matrix. In a LED matrix light source, the LEDs used fur the lighting means are arranged side by side in rows as an LED matrix. In the simplest case, an LED matrix is a matrix consisting of one row of LEDs. The alignment and suppression of the spotlight may thus be effected entirely by electrical means, without the use of any mechanically moving parts, so that both the response speed and reliability of the headlamp device are improved. In addition, the light distribution may be varied continuously by brightening or dimming the LEDs or LED cluster.

According to one embodiment of the present disclosure, the headlamp device is a multi-pixel system, in which the spotlight distribution is formed in the manner of pixels from partial light cones that lead back to single LEDs.

In one embodiment of the present disclosure, the orientation light distribution is also formed in the manner of pixels from partial light cones that lead back to single LEDs.

In one embodiment of the present disclosure, the peripheral limits of adjacent partial light cones at least partly overlap. In this way, the spotlight distribution is rendered smoother, so that the pixelated structure is less noticeable to the driver.

In one embodiment of the present disclosure, at least two adjacent light cones have angular intersections of up to 3 degrees, particularly between 0.5 and 2 degrees, more particularly between 1.0 and 13 degrees. With these intersection angles, it is possible to achieve suppression with high resolution and reduced perceptibility of the pixilation of the light distribution at the same time.

According to one embodiment of the present disclosure a LED matrix light source is also provided for the orientation light, wherein the LEDs of the orientation light source and the LEDs of the spotlight source are arranged in the manner of matrix on a shared carrier substrate. In this way, a compact, fully functional multi-pixel headlamp light source may be created simply with which both the orientation light and the spotlight can be controlled by direct actuation of the LEDs. For example, areas may be suppressed selectively by switching off or dimming one or more LEDs in the headlamp light distribution.

According to a second aspect of the present disclosure, a vehicle headlamp system is provided that includes a headlamp device according to the first aspect of the present disclosure. Said headlamp system further includes a sensor system that includes an environment sensor for detecting other road users in a given environment and a driver assistance sensor for detecting a current visibility situation of the driver. In addition, a control unit is also provided for controlling the headlamp device, wherein the headlamp system is designed such that the illumination direction of the spotlight is adjustable according to the driver's current visibility situation, and a spotlight distribution can be at least partly suppressed depending on the current traffic situation to avoid dazzling other road users.

In this way, an adaptive headlamp system is provided, in which certain areas in the driver's field of vision can be illuminated selectively based on the adjustability of the illumination direction of the spotlight according to the driver's current visibility situation and by suppression of the spotlight distribution according to the current traffic situation, without dazzling other road users in the process. Consequently, both driving safety and the overall driving experience when driving at night are enhanced.

The driver assistance sensor can be installed inside the vehicle, on the driver's side, particularly above the front windscreen. In this way, the driver's visibility situation can be detected without obstructing his vision.

In one embodiment of the present disclosure, the current visibility situation of the vehicle driver incorporates a direction in which the driver is currently looking.

In one embodiment of the present disclosure, the driver assistance sensor is designed as an “eye tracking sensor”. The driver assistance sensor thus enables an “eye tracking function” with which the driver's gaze behavior such as saccade or fixation on certain targets can be detected. From this, an area that is of interest to the driver may be determined, which is then used for aligning the spotlight. In this way, the light is directed exactly where the driver needs it, so that the headlamp light can be adapted practically instantaneously, which can be critically important particularly in hazardous situations such as deer crossing, or if a pedestrian steps into the road unexpectedly.

In one embodiment of the present disclosure, the sensor system includes a steeling wheel position sensor for detecting a current steering wheel position, and the headlamp system is designed such that the illumination direction of the spotlight can be adjusted according to the position of the steering wheel.

According to another embodiment of the present disclosure, the driver assistance sensor detects the attitude of the driver's head, from which a vision window is determined. The spotlight can then be realigned according to the driver's vision window as determined thereby. This enables the spotlight to be aligned optimally from the driver's perspective even in the absence of a particular area of interest or during straight driving.

According to a further aspect of the present disclosure, a method is provided for controlling a headlamp device in a headlamp system. A current traffic situation is detected in terms of the presence and position of other road users. A current driver visibility situation is detected. The spotlight is aligned in accordance with the driver visibility situation. The spotlight is at least partially suppressed to avoid dazzling the other road users detected. The alignment of the spotlight in accordance with the driver visibility situation and the suppression of the spotlight distribution according to the current traffic situation allow certain areas in the driver's field of vision to be illuminated selectively without dazzling other road users.

According to one embodiment of the present disclosure, the orientation light distribution remains constant relative to the spotlight distribution. In this way, the driver's own orientation capability is preserved, even if he is not looking at the road, depending on circumstances, or if he is looking beyond a maximum detection and adaptation angle of the light system.

In one embodiment of the present disclosure, an area of interest to the driver is determined from the detected current driver visibility situation, and the spotlight is directed towards this.

According to one embodiment of the present disclosure, the area of interest is determined by analysis of the saccade over a predefined detection time, in which the frequency with which the driver's gaze is directed in different directions within the detection time is evaluated. The detection time can be set within a range from 5 ms to 100 ms depending on traffic density and/or travel speed.

According to one embodiment of the present disclosure, the focus of interest is determined by calculating the length of time for which the driver's gaze is directed in different directions. For example, if the driver's gaze is directed in one direction for longer than a certain threshold time, this direction is detected as being a direction towards an area of interest, and the spotlight is aimed in this direction. The threshold time may be adjusted in a range from 5 ms to 30 ms. The setting of the threshold time may help to avoid “jittery” headlamp behavior, and thus also driver irritation, caused by unnecessary redirecting of the spotlight.

In one embodiment of the present disclosure, the intensity of the light is adapted to the respectively detected gaze direction. This guarantees that objects close to the light source—on the side of the road, for example—are not illuminated too intensively, while more distant areas of interest are lit more brightly.

In one embodiment of the present disclosure, a current position of the vehicle steering wheel is detected, and in the absence of a clear area of interest to the driver the illumination direction of the spotlight is adjusted according to the steering wheel position.

In one embodiment of the present disclosure, the spotlight is provided in the form of an unscreened main beam, in which individual light segments illuminate the driver's area of interest disproportionately, while other road users that have been detected are suppressed to avoid dazzling them.

According to a further aspect of the present disclosure, a vehicle is described in which a headlamp system according to the first aspect of the present disclosure is fitted, so that the illumination direction of the spotlight is adjustable according to the driver's current visibility situation, and the spotlight distribution may be at least partly suppressed according to the current traffic situation to avoid dazzling other road users. In this way, the vehicle is equipped with an adaptive headlamp system, in which certain areas in the driver's field of vision can be illuminated selectively based on the adjustability of the illumination direction of the spotlight according to the driver's current visibility situation and by suppression of the spotlight distribution according to the current traffic situation, without dazzling other road users in the process

In one embodiment, the vehicle is equipped with an environment sensor, which is arranged in a front area of the vehicle. In one embodiment, the environment sensor is designed as an optical sensor. In this context, the optical sensor is preferably arranged in a frontal area of the vehicle, Thus it can be guaranteed that the viewing field of the optical sensor is at least partly coincident with the light cone of the vehicle headlamp, which serve to illuminate the travel path of the vehicle.

According to one embodiment, the optical sensor is a camera. Such camera systems integrated in standard motor vehicles are known, for delivering data for a large number of driver assistance systems, for example, which means that their function can be used without the need to carry out complex and costly conversions. For example, the optical sensors may be a component of a blind spot monitoring system for observing vehicles that are overtaking or travelling in an adjacent lane, wherein the sensors from at least one camera may be located in the rear view mirror or in the area of the rear view mirror of the vehicle.

According to a further embodiment the optical sensor is a radar system. The term radar is used as a general term for all direction finding devices based on electromagnetic waves outside the visible spectrum, in the radio frequency range. On this basis, radar is particularly well suited for detecting the presence of any overtaking vehicles on poorly lit roads. Radar systems are also known as components of many driver assistance systems, for example to assist a driver in traffic, when changing lanes for example, which means that their function can be used without the need to carry out complex and costly conversions.

According to a further embodiment, the optical sensor may also be a lidar system. The basis function of a lidar system consists in measuring distances, The instrument emits laser pulses and detects the light that is scattered back by an object. An object can be detected, and particularly the distance to the object can be calculated from the travel time of the signals and the speed of light. In this way, the light from the laser that is reflected back from the surface of an object enables conclusions to be drawn regarding the speed and position of the object, as in the case of an over-taking vehicle, for example.

The optical sensor may further be any other optical sensor that is capable of detecting an overtaking or oncoming vehicle.

### BRIEF DESCRIPTION OF THE DRAWINGS

The present disclosure will hereinafter be described in conjunction with the following drawing figures, wherein like numerals denote like elements.

FIG. 1 is a schematic representation of headlamp light distribution according to a first embodiment of the present disclosure without oncoming traffic;

FIG. 2 is a schematic representation of headlamp light distribution according to the embodiment of FIG. 1 with oncoming traffic;

FIG. 3 is a schematic representation of headlamp light distribution according to a second embodiment of the present disclosure without oncoming traffic;

FIG. 4 is a schematic representation of headlamp light distribution according to the second embodiment of the present disclosure with oncoming traffic;

FIG. 5 is a schematic representation of an optical arrangement for generating an orientation light according to the first embodiment of the present disclosure;

FIG. 6 is a schematic representation of an optical arrangement for generating a spotlight according to the first embodiment of the present disclosure;

FIG. 7 is a schematic representation of an optical arrangement of a multi-pixel headlamp;

FIG. 8 is another schematic representation of an optical arrangement of a multi-pixel headlamp; and

FIG. 9 shows a headlamp system according to the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

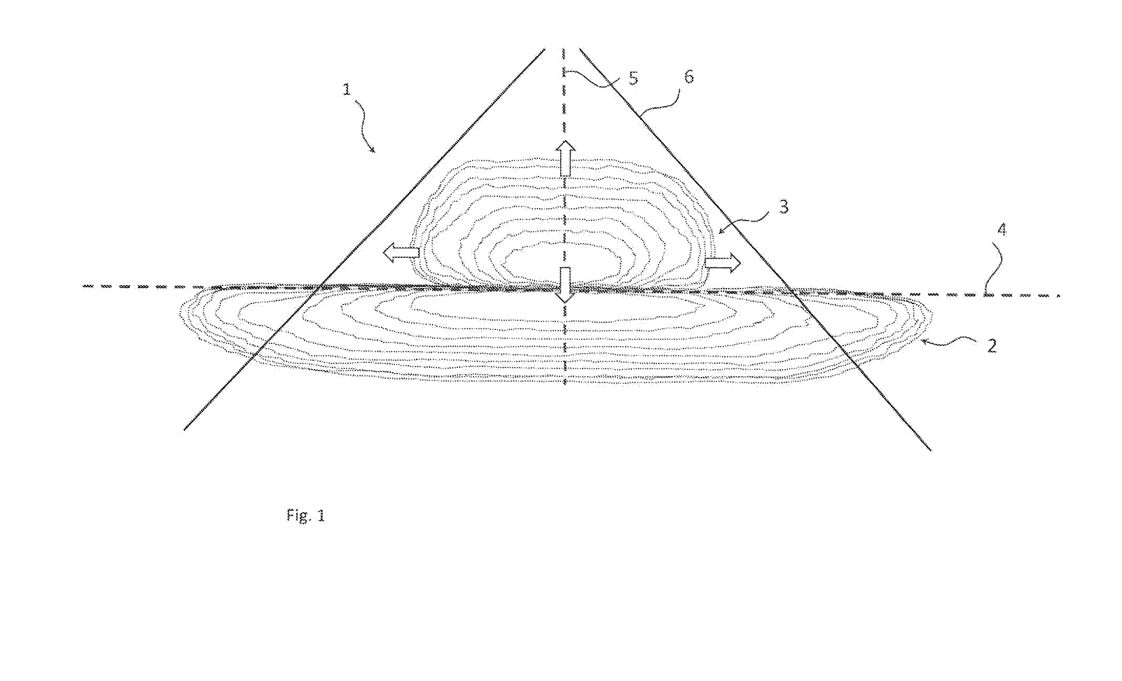

FIG. 1 is a schematic representation of headlamp light distribution according to a first embodiment of the present disclosure without oncoming traffic. For purposes of clearer display, the light distributions are represented by lines with the same luminous intensity. The headlamp light with a headlamp light distribution 1 includes an orientation light with an orientation light distribution 2 and a spotlight with a spotlight distribution 3, so that headlamp light distribution 1 in FIG. 1 is formed essentially from these two light distributions.

The headlamp light distribution 1 represented in FIG. 1 corresponds to a driving situation on a road or motorway without oncoming traffic. The two solid slanted lines serve as a schematic representation of carriageway 6. Orientation light distribution 2 is lower than spotlight distribution 3 and is generally broader than spotlight distribution 3. The horizontal, dashed line represents the “glare line” 4 and is the line of intersection between image plane and the glare plane, which defines an upper limit of the suppressed light. Orientation light distribution 2 is below the glare line, so that oncoming traffic cannot be dazzled by the orientation light. The vertical dashed line represents carriageway centerline 5 in the direction of travel. Headlamp light distribution 1 in FIG. 1 is substantially in mirror symmetrical arrangement relative to road centerline 5.

A sensor system with an environment sensor and a driver assistance sensor collects information about the driver's current visibility situation and a current traffic situation in terms of the presence and position of other road users in the environment of the vehicle. The driver's current visibility situation is detected via an eye tracking sensor.

The light distribution may be actuated by a control unit for the headlamp on the basis of information collected by the sensor system. Alternatively, the driver assistance sensor may determine the position of the driver's head and so determine the driver's vision window.

The spotlight distribution may be shifted horizontally and vertically. This is made illustrated by the horizontal and vertical arrows in FIG. 1. In this example, the horizontal and vertical shift of the illumination direction of the spotlight is effected by means of adjustable optical elements of the headlamp. As may be evident from the luminous intensity lines of the light distributions, the luminous intensity is greater in the middle area of the spotlight light distribution than in the outer areas.

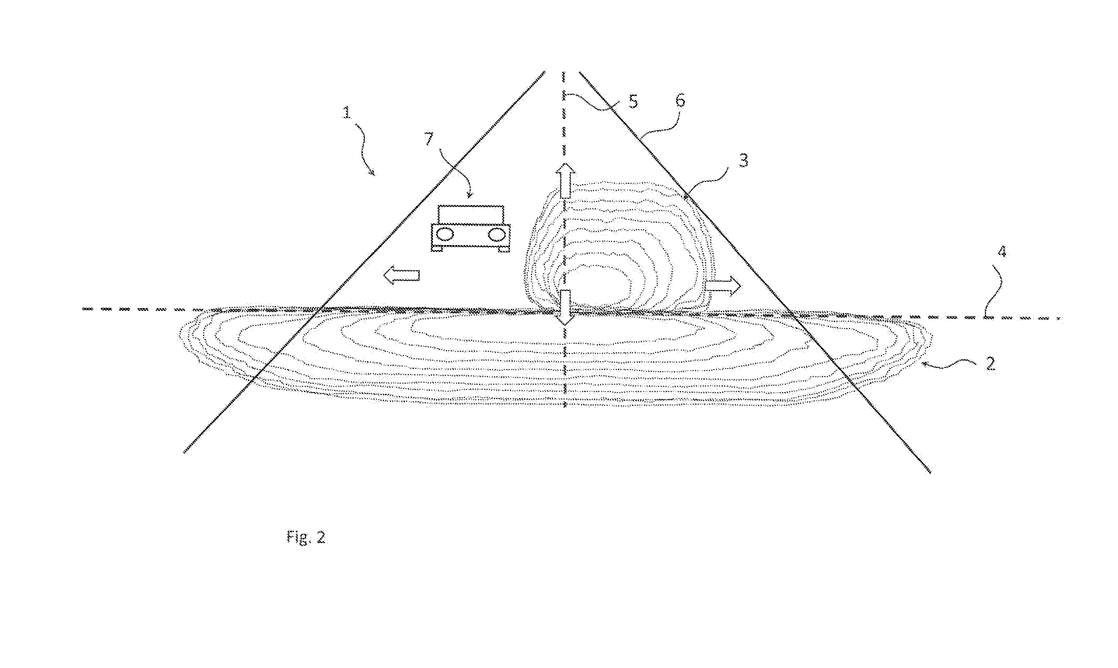

FIG. 2 is a schematic representation of headlamp light distribution according to the embodiment of FIG. 1 with oncoming traffic. In this case, headlamp light distribution 1 has been adapted so that oncoming vehicle 7 ion carriageway 6 is not dazzled. This is achieved with a corresponding restriction of the spotlight's light cone. In this case, spotlight distribution 3 is essentially limited to the right half of the original spotlight distribution (see FIG. 1). In this case, it is not necessary to adapt the orientation light, since the orientation light distribution is below the glare line.

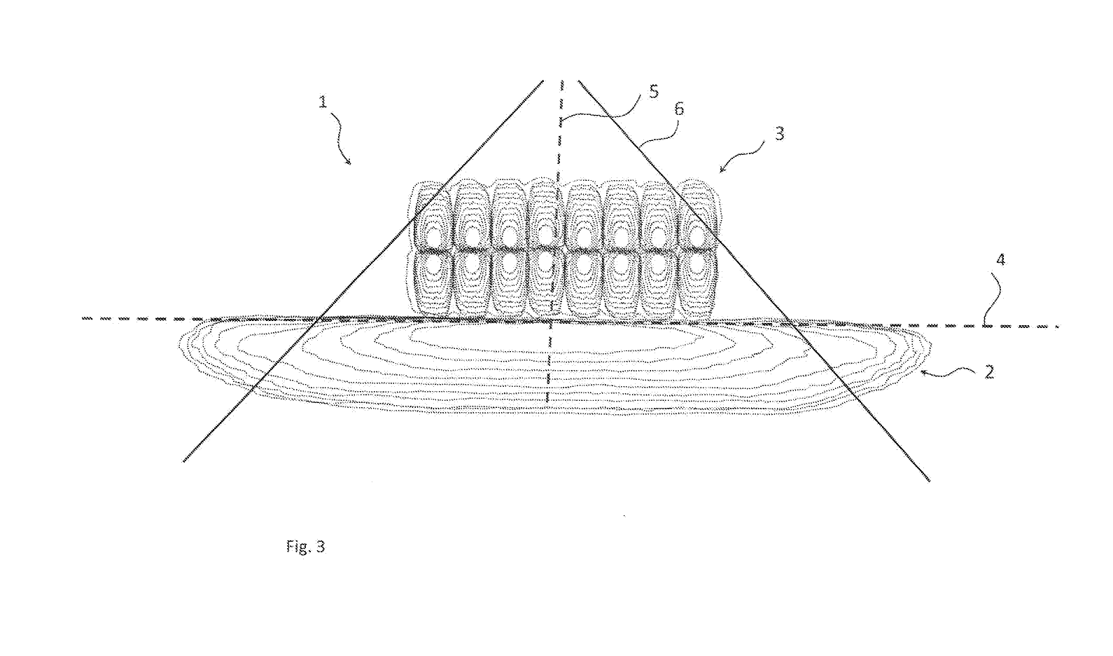

FIG. 3 is a schematic representation of headlamp light distribution according to a second embodiment of the present disclosure without oncoming traffic The light distribution shown in FIG. 3 corresponds to a “multi-pixel headlamp” light distribution. In this context, spotlight distribution 3 is formed in the manner of pixels from partial light cones that are arranged very closely together—some of which overlying their neighbors so that the peripheral limits of adjacent partial light cones at least partly intersect.

In this example the angular overlaps of adjacent pixels are in the order of about 1.2 degrees. In this example, spotlight distribution 3 includes two rows of pixels arranged one above the other.

A LED matrix light source is provided as the light source for the spotlight; each individual pixel may be traced back to individual LEDS, which are individually controllable. Thus, the spotlight distribution can be modified at the pixel level by brightening or dimming individual LEDs.

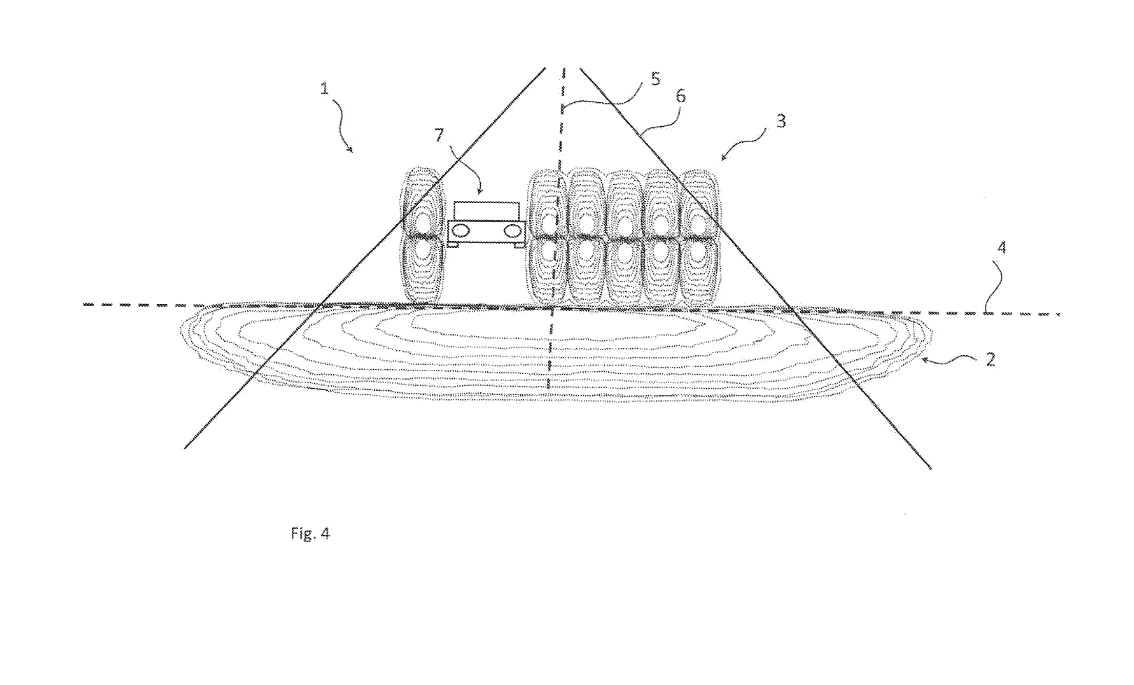

FIG. 4 is a schematic representation of headlamp light distribution according to the second embodiment of the present disclosure with oncoming traffic. In this case, headlamp light distribution 1 has been adapted so that the oncoming traffic, represented here as an oncoming vehicle 7 on carriageway 6, is not illuminated. For this purpose, two segments in each of the two rows of pixels, that is to say four pixels in total, are suppressed. This example illustrates how the spotlight function and the suppression function can be combined simply.

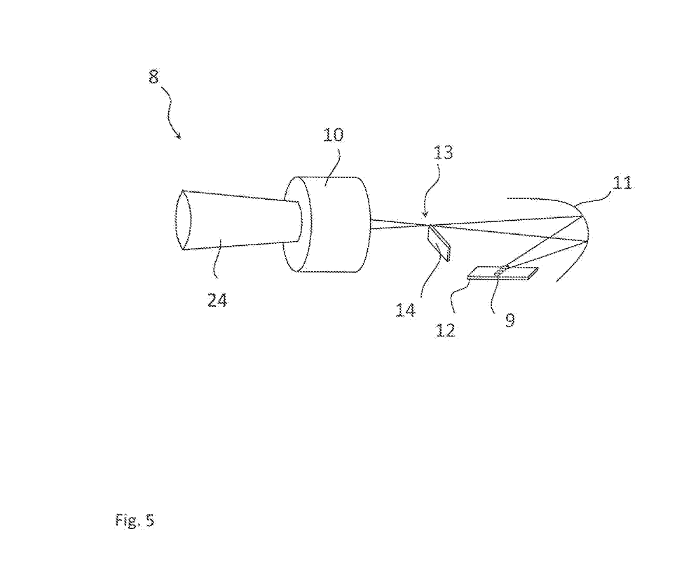

FIG. 5 is a schematic representation of an optical arrangement for generating an orientation light according to the first embodiment of the present disclosure. The optical arrangement for generating an orientation light 8 includes LEDs 9 as lighting means and an optics system that includes a lens 10 and a reflector 11. LEDs 9 are arranged in a row on a substrate 12. The beam path shown in FIG. 5 has a focus area 13, in which screen 14 is placed. Screen 14 serves to define an upper edge of the orientation light distribution such that the orientation light does not cross over the glare line.

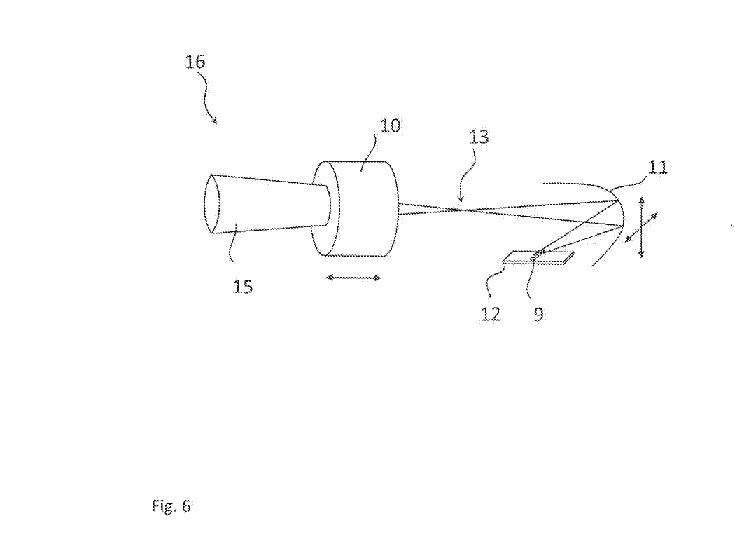

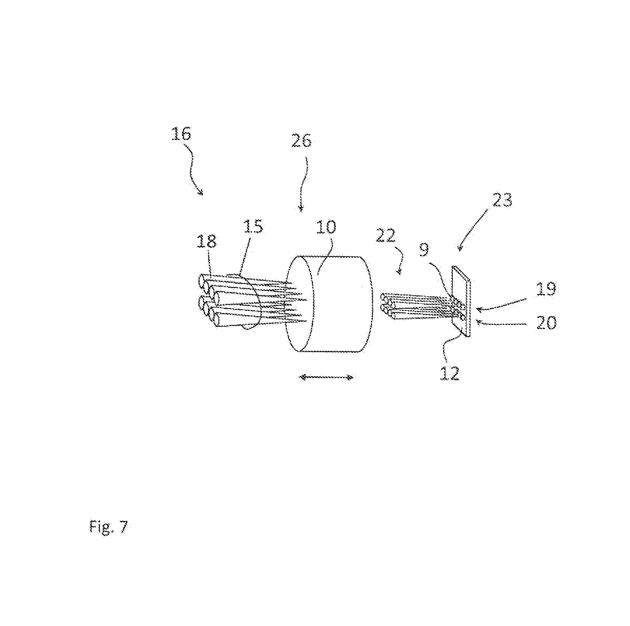

FIGS. 6-7 are a schematic representation of an optical arrangement for generating a spotlight according to the first embodiment of the present disclosure. To some degree, optical arrangement 16 for generating the spotlight is very similar to optical arrangement 8 of FIG. 5 for generating the orientation light. Therefore, corresponding parts in FIG. 5 and FIGS. 6-7 are identified with the same reference numbers. In this optical arrangement, lens 10 is an adjustable lens. Reflector 11 is an adjustable reflector. The double-headed arrows close to reflector 11 and lens 10 illustrate the displacement capabilities of these optical elements. The horizontal and vertical adjustment of the reflector enables the illumination direction of the spotlight to be adjusted according to vehicle driver's current visibility situation. In this embodiment, the width of the spotlight distribution may be altered by adjusting lens 10.

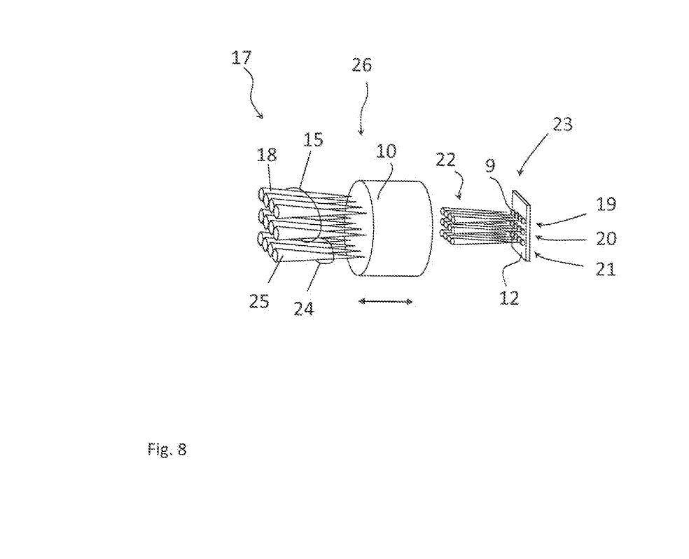

FIG. 8 is a schematic representation of an optical arrangement of a multi-pixel headlamp. Optical arrangement 16, 17 of the multi-pixel headlamp includes a multi-pixel light source 23 with LEDs 9 that are arranged on a carrier substrate 12 in four columns and three rows 19, 20, 21. The two upper LED rows 19 and 20 serve to generate the spotlight, while the lower row of LEDs 21 generate the light for the orientation light. In this way, the orientation light and the spotlight are realized in the same optical arrangement, in which LEDs 9 for both the orientation light source and the spotlight source are arranged on a common, matrix-like carrier substrate 12. In this case, carrier substrate 12 is a ceramic substrate. Alternatively, a metal core board may also be used as the carrier substrate for LEDs.

The primary light emitted by LEDs 9 to generate the spotlight and the orientation light is represented schematically by small light cones 22. The total light distribution of the headlamp light, consisting of both the spotlight and the orientation light, is shaped by an optics system that serves both light components. Optical arrangement 17 includes a lens optics system 26 with an adjustable lens 10′ for this purpose.

Light cone 15 of the spotlight is formed by partial light cones 18, which can be traced back to individual LEDs 9 in rows 19 and 20. Light cone 15 of the orientation light is formed by partial light cones 25, which can be traced back to individual LEDs 9 in rows 21. In this way, both the spotlight function and the orientation light function are provided in simple manner by the optical arrangement shown in FIGS. 7 and 8, with a common optics system and a common carrier substrate for LEDs. At the same time, the light distributions of both the orientation light and the spotlight are created with pixels from partial light cones 18 in such manner that the spotlight distribution 3 and the orientation distribution 2 can be both shaped and steered by actuating the LEDs.

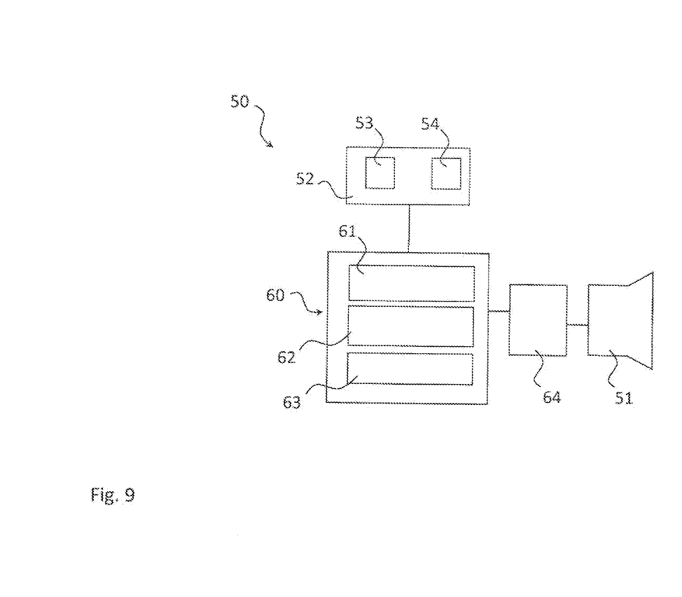

FIG. 9 shows a headlamp system according to the present disclosure of a vehicles according to a second aspect of the present disclosure. Headlamp system 50 includes a headlamp device 51 according to the first aspect of the present disclosure. Headlamp system 50 includes a sensor system 52 with an environment sensor 53 for detecting other road users in the surroundings of the vehicle, and a driver assistance sensor 54 for detecting a currant visibility situation of the driver. Headlamp system 50 further includes a control unit 40 for controlling headlamp device 51. In addition, headlamp system 50 includes a control unit 60 and a headlamp controller 65 for controlling a headlamp system 51 of the vehicle.

Sensor device 52 is designed to collect data from environment sensor 53 and driver assistance sensor 54. Control unit 60 includes a receiver interface 61 for receiving data representing information about a current visibility situation of the driver and about the environment of the vehicle. The control unit further includes an evaluation unit 63 for determining whether a current controlled state of headlamp device 51 needs to be adapted based on the data received. Control unit 60 further includes an output interface 64 for outputting signals to a headlamp controller 65. Evaluation unit 62 is designed to instruct output interface 63 to output signals to headlamp controller 64 for adapting the current controlled state of headlamp device 51.

While at least one exemplary embodiment has been presented in the foregoing detailed description, it should be appreciated that a vast number of variations exist. It should also he appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A headlamp device for a vehicle configured to generate a light beam comprising a directed spotlight with an illumination direction and a spotlight distribution operable for at least partly dimming to avoid dazzling other road users, and an orientation light having a broader orientation light distribution than the spotlight operable for adjustment horizontally and vertically.

17. The headlamp device according to claim 16, wherein a distribution of the orientation light is essentially below a glare plane.

18. The headlamp system according to claim 17, wherein the spotlight distribution is essentially above the glare plane.

19. The headlamp device according to claim 16, wherein when the spotlight distribution is not suppressed, and a central area of the spotlight distribution has greater luminous intensity on average than a peripheral area of the spotlight distribution.

20. The headlamp device according to claim 16, further comprising east one semiconductor source are provided to generate the light beam.

21. The headlamp device according to claim 20, further comprising a LED matrix light source operable as the spotlight source, and wherein the illumination direction and suppression of the spotlight are adjustable by actuation of LEDs of the LED matrix.

22. The headlamp device according to claim 21, wherein the LED is realized as part of a hybrid LED matrix comprising LEDs for both the directed spotlight and the orientation light, wherein a distribution of the orientation light and the spotlight are formed by a common optics system, and wherein the LEDs of the hybrid LED matrix are arranged in columns and rows on a common carrier substrate in such manner that at least one row of the LEDs is assigned to the orientation light and at least one row of the LEDs is assigned to the spotlight.

23. The headlamp device according to claim 22, wherein the common optics system comprises an adjustable lens.

24. The headlamp device according to claim 22, wherein at least one of the spotlight distribution or orientation light distribution are formed in the manner of pixels from partial light cones that lead back to individual LEDs, and wherein the peripheral limits of adjacent partial light cones at least partly overlap.

25. The headlamp device according to claim 24, wherein at least two adjacent partial light cones have an angular intersection up to at least 3 degrees.

26. The headlamp device according to claim 25, wherein the angular intersection is in a range of 0.5 and 2 degrees.

27. The headlamp device according to claim 26, wherein the angular intersection is in the range of 1.0 and 1.3 degrees.

28. A headlamp system of a vehicle comprising a headlamp device according to claim 16, any one of the preceding claims, a sensor system comprising an environment sensor for detecting other road users in a given environment and a driver assistance sensor for detecting a current visibility situation of the driver, and a control unit for controlling the headlamp device, wherein the headlamp system is configured such that the illumination direction of the spotlight is adjustable according to the driver's current visibility situation, and a spotlight distribution can be at least partly suppressed depending on the current traffic situation to avoid dazzling other road users.

29. The headlamp system according to claim 28, wherein the current visibility situation of the vehicle driver comprises a current gaze direction and/or the driver's current vision window.

30. A vehicle, equipped with a headlamp system according to any one of claims 28 configured such that the illumination direction of the spotlight is adjustable according to the driver's current visibility situation, and the spotlight distribution is at least partly suppressed according to the current traffic situation to avoid dazzling other road users.

31. A method for controlling a headlamp device in a headlamp system comprising:
detecting a current traffic situation in terms of the presence and position of other road users;
detecting a current driver visibility situation;
aligning the spotlight in accordance with the driver visibility situation; and
at least partially suppressing the spotlight to avoid dazzling the other road users detected.

32. The method according to claim 31, further comprising determining an area of interest to the driver from the detected current driver visibility situation, and directing the spotlight towards this area of interest.
